(19) United States
(12) Patent Application Publication
(10) Pub. No.: US 2004/0070268 A1
(43) Pub. Date: Apr. 15, 2004

(54) Motor vehicle steering system having a yaw rate controller

(75) Inventor: Goetz Baumgarten, Karlsfeld (DE)

Correspondence Address: CROWELL & MORING LLP, INTELLECTUAL PROPERTY GROUP, P.O. BOX 14300, WASHINGTON, DC, 20044-4300, US

(73) Assignee: Bayerische Motoren Werke Aktiengesellschaft

(21) Appl. No.: 10/681,313

(22) Filed: Oct. 9, 2003

Related U.S. Application Data
(63) Continuation of application No. PCT/EP02/08446, filed on Jul. 30, 2002.

(30) Foreign Application Priority Data
Aug. 23, 2001 (DE) 101 41 274.6

(51) Int. Cl. B60T 8/60

(52) U.S. Cl. 303/146

(57) ABSTRACT

A motor vehicle steering system includes a yaw rate controller that continuously detects a yaw rate representing the vehicle yawing motion, forms a control signal as a function thereof, and causes a steering movement that counteracts the undesired yawing motion. The control signal is formed differently in the unbraked driving condition than when the vehicle is braked. In addition, the control signal in the case of a control intervention of a brake control system may be formed differently than when the vehicle is braked without such a control intervention. Preferably, the control signal which is determined from the deviation between a desired yaw rate value and the actual yaw rate value, in the case of a controlled braking operation, is formed by means of at least one other amplification factor (kₚ) that differs from that which is used in the unbraked driving condition. In the deviation branch, in addition to the proportional fraction, an integral fraction may be provided whose amplification factor (k_{I}) in the case of a braking operation has a different value than in the unbraked driving condition.

### CROSS-REFERENCE TO RELATED APPLICATIONS

This application is a continuation of PCT Application No. PCT/EP02/08446 filed on Jul. 30, 2002.

### BACKGROUND AND SUMMARY OF THE INVENTION

This application claims the priority of German patent document 101 41 274.6, filed Aug. 23, 2001, the disclosure of which is expressly incorporated by reference herein.

The invention relates to a motor vehicle steering system having a yaw rate controller which continuously detects the vehicle yaw rate, forms a control signal as a function thereof and causes a steering movement that counteracts any undesired yawing motion.

German Patent Document DE 197 51 227 A1 describes a method and apparatus for operating a motor vehicle steering system in which active steering intervention is switched on to improve the yaw behavior of a vehicle, only when an outside disturbance of the vehicle movement is detected. One instance which is given as an example of such a disturbance is μ-split ABS braking, in which a double-track vehicle swerves toward the side of the high-coefficient-of-friction side, absent additional measures. Such swerving is caused by the yawing moment that occurs during ABS interventions due to different braking forces being applied on the left and right vehicle sides.

German Patent Document DE 197 51 227 A1 also mentions a so-called yawing moment compensation to prevent this effect by means of brake pressures which differ at the left and right vehicle wheels. For this purpose, the brake pressures are measured, and from their difference a control command is computed, for example for a servo motor of a superimposed steering, and thus a steering movement counteracting the undesirable yawing motion is started. With respect to the control, this yawing moment compensation is a disturbance variable feed forward.

It is noteworthy that, during a braking operation while the vehicle is cornering, different brake pressures also occur on the left and on the right respectively due to the different normal forces which occur at the inside and outside wheels during the cornering, Therefore, a control command is also generated during the cornering, tending to steer the vehicle too much toward the “cornering interior”, which is why the yawing moment compensation is less suitable for cornering with a higher lateral acceleration. Furthermore, there are additional influences on the so-called disturbance yawing moment for which no sensors are available in the vehicle, such as different coefficients of frictions of the brake disks or temperatures of the brake disks on the left and the right vehicle sides, or different tire brands, the degree of wear of the tires, and the like.

While a yawing moment compensation attempts to determine quantitatively the cause of the disturbing yawing motion of the vehicle (specifically, the disturbing yawing moment which influences the yaw acceleration and thus may build up a yaw rate), to avoid the above-mentioned disadvantages, German Patent Document DE 197 51 227 A1 suggests directly determining and combating the undesirable effect itself, specifically the yaw rate. For this purpose, an independent yaw rate control is suggested which is connected only in a special vehicle braking situation, specifically during a braking on a μ-split roadway. An additional controller is provided, which becomes active only in the above-mentioned special cases.

One object of the invention is to provide an improved yaw rate controller of the type described above, which is more efficient than those of the prior art.

This and other objects and advantages are achieved by the vehicle yaw rate controller according to the invention, in which the control signal is generally formed differently when the vehicle is in an unbraked driving condition than when it is braked.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic diagram of a yaw rate controller according to the invention;

FIG. 2 is a flow chart that illustrates a first embodiment of the processing according to the invention; and

FIG. 3 is a flow chart that illustrates a second embodiment of the processing according to the invention.

### DETAILED DESCRIPTION OF THE DRAWINGS

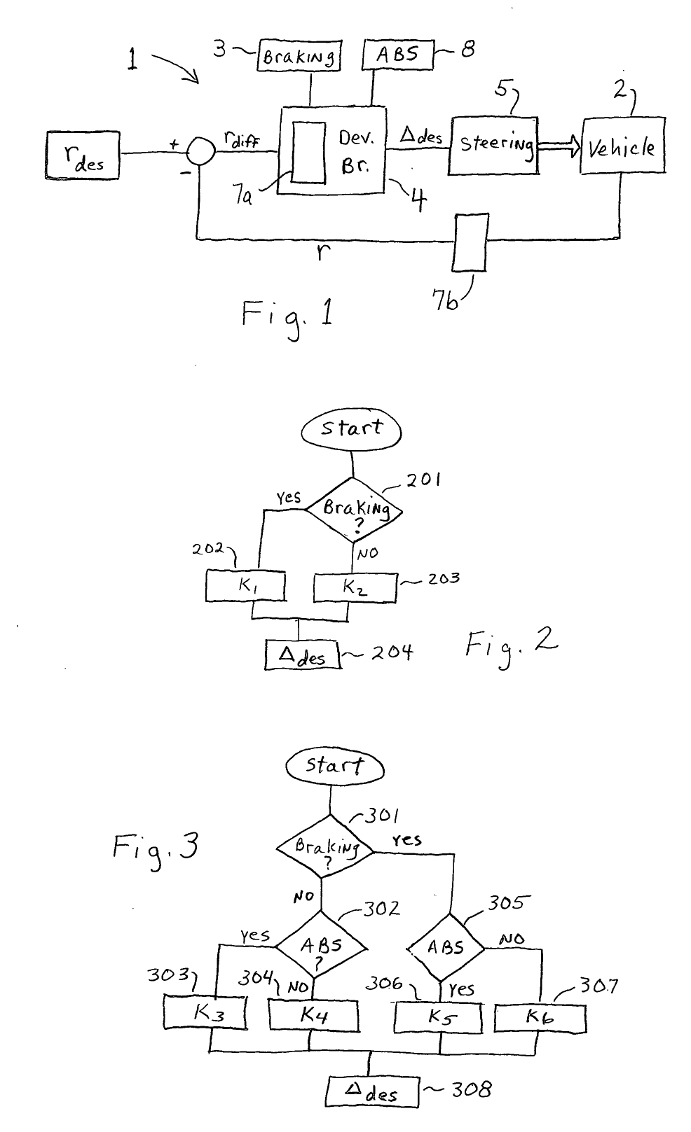

Referring to FIG. 1, the vehicle 2 has a single yaw rate controller 1, which is responsible for virtually all driving conditions but nevertheless has a control characteristic that varies as a function of the driving condition. In this case, the criterion for differentiating the different driving conditions is whether an unbraked condition exists or the vehicle is braked, as determined by braking detection 3. In particular, the yaw rate control should respond faster and stronger in the case of a braking of the vehicle than in an unbraked driving condition.

It should be mentioned in this regard that, in principle, yaw rate control is not quite as fast as yawing moment compensation, because the latter directly combats the yaw acceleration. However, compensation by yaw rate control is still sufficiently fast if a deviation branch (that is, the “error” branch of a feedback control loop) is provided which permits a response that is as early as possible in the case of small deviations in order to achieve, for example, a fast countersteering in the event of μ-split braking. This is ensured when the control signal (which is determined from the difference between the desired yaw rate value r_{des} and the actual yaw rate value r during a braking operation) is formed by means of at least one amplification that differs from (especially, is greater than) that in the unbraked driving condition.

In a preferred embodiment of the invention, the yaw rate controller 1 (which is always running) may, for example, determine a so-called desired yaw rate value r_{des} (FIG. 1) and, taking into account an actually measured yaw rate r, compute the deviation (r_{diff}) as follows:

(r_{diff})=(r_{des})−(r) (Equation 1)

This deviation is processed (in the deviation branch 4 of the control system) to form a control signal (Δ_{des}), which causes a corresponding steering movement 5. In the simplest case, the deviation branch consists of a “scaling” or proportional amplification (kₚ) of (r_{diff}), thus:

(Δ_{des})=(kₚ)·(r_{diff}) (Equation 2)

In this proportional component of the deviation branch, the value of the amplification factor (kₚ) in the unbraked condition is lower than when the vehicle is braked.

The deviation branch can be expanded in a manner that permits stationary countersteering which is as precise as possible, particularly in the event of μ-split braking, so that the need for the driver to countersteer is virtually eliminated during the entire braking operation. This can be implemented by the incorporation of an I-element in the deviation branch, preferably in addition to the proportional fraction, with the amplification factor (k_{I}) of the I-component having a value during a braking operation, which differs from that which is used in an unbraked driving condition.

As a further embodiment of the above-mentioned example, the control signal (Δ_{des}) will then be formed as follows:

(Δ_{des})=(kₚ)·(r_{diff})+(k_{I})·∫(r_{diff}(t))dt (Equation 3)

In addition, as an advantageous further embodiment, in the event of a braking operation, a filter in the deviation branch can be changed or activated in comparison to the unbraked driving condition. Here, the possibilities include rate action filters, noise suppression filters or a so-called dead zone. In this case, such changed filters 7a, 7b or the like, in addition to the deviation branch or as an alternative thereto, may also be provided in the return (feedback) branch 6 of the corresponding signal, which also applies to the changed amplification factor or the like.

It should also be noted that a corresponding changed formation of the control signal may differ not only between a braked and an unbraked driving condition but that, also in the case of a control intervention of a brake control system 8 (FIG. 1), the control signal may be formed in a different manner than when the vehicle is braked without such a control intervention (particularly an ABS).

To detect whether the vehicle is in a braked or an unbraked driving condition, information can be utilized which is already present in the vehicle. Thus, a braking operation may be detected, for example, from the activation of a vehicle brake light switch and/or from a pressure change in the hydraulic vehicle braking system, represented schematically by block 3 in FIG. 1. Also flags in the ABS control may supply corresponding information in order to especially adapt the deviation branch as described, depending on the situation during braking operations or ABS interventions.

FIG. 2 is a flow chart that illustrates the selection of an amplification factor, based on whether a braking operation is in progress. In step 201 a determination is made whether the brakes are actuated, for example, according to whether or not the vehicle brake light switch is activated, as described previously. If so, a first amplification factor K₁, is selected in step 202. If not, however, in step 203 a second amplification factor K₂ is selected, which differs from K₁. Thereafter, in step 204 the control signal Δ_{des} is calculated in the manner described previously according to equation 2 or 3. (If equation 3 is used, amplification factor values are selected for both the proportional and integral components.)

FIG. 3 shows a further embodiment of the invention, in which a distinction is made, based on whether an automatic braking intervention (ABS) is activated. In step 301, it is determined whether the driver has activated a braking operation. If not, a further determination is made in step 302 whether an automatic braking intervention is taking place. If it is, then amplification factor K₃ is selected in step 303, while if it is not, a different amplification factor K₄ is selected in step 304. If, on the other hand, the brakes are being applied by the driver in step 301, then a determination is made in step 305, whether automatic braking is taking place, and either amplification factor K₅ is selected in step 306, or K₆ is selected in step 307, depending on the result. Thereafter, the control signal Δ_{des} is calculated in step 308 in the same manner as in FIG. 2, using the selected amplification factor(s).

To this extent, the present invention is more advantageous than the state of the art known from the initially mentioned Germnan Patent Document DE 197 51 227 A1, which is directed at the detection of the special μ-split braking condition, and therefore requires at least two brake pressure sensors (specifically front left and front right). In contrast, the present invention emphasizes the detection of a general braking condition, specifically, irrespective of whether or not there is a μ-split. Thus, special brake pressure sensors are not required because the deviation branch is always changed in the same manner during the braking, regardless of whether there is a μ-split condition. At most, a distinction is made between braking with or without the intervention of a brake pressure control system; however, no brake pressure sensors are required for its detection.

For the driver of the vehicle, it is particularly important to avoid an unanticipated swerving of the vehicle at the first moment of braking, (that is, within the time period of the so-called “scare second”). Subsequently, when the braking operation continues in a steady-state manner, the driver will usually be able to compensate by means of the steering wheel the then steady-state yawing moment, which is caused, for example by μ-split conditions, by means of a steady-state steering wheel angle. For this reason, the present invention puts more emphasis on the proportional fraction in the deviation branch, while, for example, in the above-mentioned German Patent Document DE 197 51 227 A1, more emphasis is put on the integral fraction.

In addition, the present invention generally permits a compensation of the yawing tendency during braking operations when cornering. Also, no unfavorable interactions can occur with vehicle stabilizing systems which intervene in the vehicle braking system because the brake pressure differences caused by such stabilizing devices do not result in a steering intervention in the case of the present invention.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A motor vehicle steering system having a yaw rate controller which continuously detects a yaw rate representing the vehicle yawing motion and forms a control signal as a function thereof, and which causes a steering movement which counteracts the undesired yawing motion, wherein the control signal is formed differently in an unbraked driving condition than when the vehicle is braked.

2. The motor vehicle steering system according to claim 1, wherein the control signal in the case of a control intervention of a brake control system is formed differently than when the vehicle is braked without such a control intervention.

3. The motor vehicle steering system according to claim 1, wherein:
the control signal is determined from the deviation between a desired yaw rate value and the actual yaw rate value; and
in the event of a controlled braking operation, the control signal is formed by means of at least one amplification factor that differs from an amplification factor that is used in the unbraked driving condition.

4. The motor vehicle steering system according to claim 3, comprising a deviation branch which generates the control signal that includes a proportional component and an integral component, the integral component having an amplification factor that has a different value in the case of a braking operation than in the unbraked driving condition.

5. The motor vehicle steering system according to claim 1, wherein the deviation branch or a return branch includes a filter whose operation is changed or activated in the case of a braking operation in contrast to the unbraked driving condition.

6. The motor vehicle according to claim 1, wherein a braking operation is detected based on one of activation of a vehicle brake light switch and pressure change in the hydraulic vehicle braking system.

7. A yaw rate control device, for controlling yawing movement of a vehicle, said yaw rate control device comprising:
means for providing a signal indicative of a desired yaw rate for said vehicle;
means for generating a signal indicative of an actual yaw rate for said vehicle;
comparison means for generating a deviation signal equal to the difference between said desired yaw rate signal and said actual yaw rate signal;
means for calculating a control signal for controlling vehicle steering as a function of said deviation signal, using at least one amplification factor; and
means for determining whether a vehicle operator is currently activating a vehicle braking operation;
wherein the at least one amplification factor has a value that varies as a function or whether or not a vehicle braking operation is currently activated.

8. The yaw rate control device according to claim 7, further comprising:
means for determining whether an automatic braking intervention is occurring;
wherein the value of the at least one amplification factor varies further as a function of whether an automatic braking intervention is currently occurring.

9. The yaw rate control device according to claim 7, wherein said means for calculating a control signal incorporates a proportional component that uses a first amplification factor for the proportional component.

10. The yaw rate control device according to claim 9, wherein said means for calculating a control signal incorporates an integral component that uses a second amplification factor for the integral component, the control signal being equal to the sum of the proportional and integral components.

11. A method for controlling yawing movement of a vehicle, comprising:
providing a signal indicative of a desired yaw rate for said vehicle;
generating a signal indicative of an actual yaw rate for said vehicle;
calculating a control signal as a function of a difference between said signals that are indicative of the desired yaw rate and the actual rate, using at least one amplification factor;
adjusting vehicle steering as a function of said control signal;
determining whether a vehicle operator is currently activating a vehicle braking operation; and
varying a value of said amplification factor as a function of whether or not a vehicle braking operation is currently activated.

12. The method according to claim 11, further comprising:
determining whether an automatic braking intervention is occurring;
wherein the value of the at least one amplification factor varies further as a function of whether an automatic braking intervention is currently occurring.

13. The method according to claim 11, wherein said control signal includes a proportional component that is calculated using a first amplification factor.

14. The method according to claim 13, wherein:
the control signal incorporates an integral component that is calculated using a second amplification factor; and
the control signal is equal to the sum of the proportional and integral components.
